(19) United States
(12) Patent Application Publication
(10) Pub. No.: US 2024/0026510 A1
(43) Pub. Date: Jan. 25, 2024

(54) METHOD OF DROSS EXTRACTION USING HEATED NITROGEN AND ACCUMULATED PRESSURE DISPLACEMENT NOZZLES

(71) Applicant: Cleveland-Cliffs Steel Properties Inc., West Chester, OH (US)

(72) Inventor: Joshua Wayne THOMPSON, Evansville, IN (US)

(21) Appl. No.: 18/225,347

(22) Filed: Jul. 24, 2023

Related U.S. Application Data
(60) Provisional application No. 63/391,944, filed on Jul. 25, 2022.

(51) Int. Cl. C23C 2/00

(52) U.S. Cl. CPC C23C 2/00342

(57) ABSTRACT

An apparatus for pumping molten metal includes a transport conduit and a gas conduit. The transport conduit includes an inlet portion and an exit portion. The inlet portion defines an inlet port. The exit portion defines an exit diameter and an exit port. The inlet port is in communication with the exit portion to communicate molten metal from the inlet port to the exit port. The gas conduit defines a gas delivery conduit. The gas delivery conduit is in communication with the exit portion and defines a gas delivery diameter. A ratio of the gas delivery diameter to the exit diameter is 0.5 or more.

### PRIORITY

This application claims priority to U.S. Provisional Application Ser. No. 63/391,944, entitled “Method of Dross Extraction Using Heated Nitrogen and Accumulated Pressure Displacement Nozzles,” filed on Jul. 25, 2022, the disclosure of which is incorporated by reference herein.

### BACKGROUND

The present invention pertains to molten metal pumps used to manipulate molten metal from one location to another. Molten metal pumps may rely on gas displacement to drive movement of molten metal without the use of moving parts in physical contact with the molten metal. One type of molten metal pump may be referred to as an “air lift pump,” or a “bubble pump” in some circumstances. In such molten metal pumps, gas may be injected into molten metal to generate bubbles of the injected gas within the molten metal. The presence of bubbles within the molten metal may lead to a localized reduction in density of the molten metal relative to the surrounding molten metal, thereby driving a flow of molten metal through a tube or other conduit.

Examples of molten metal pumps are described in U.S. Pat. No. 5,650,120, entitled “Bubble-Operated Recirculating Pump for Metal Bath,” issued on Jul. 22, 1997; U.S. Pat. No. 5,863,314, entitled “Monolithic Jet Column Reactor Pump,” issued on Jan. 26, 1999; and U.S. Pat. No. 6,051,183, entitled “Jet Column and Jet Column Reactor Dross Removing Dross Diluting Pumps,” issued on Apr. 18, 2000, the disclosures of which are incorporated by reference herein in their entirety.

Molten metal pumps may be used in a variety of circumstances. By way of example only, one such circumstance may be to remove or dilute dross from the surface of a molten metal bath. Dross may form, for example, in hot dip galvanizing, galvannealing, or aluminizing lines when the molten coating material is incidentally exposed to contaminants such as oxygen, and/or etc. In the presence of such contaminants, the coating material may react and form certain undesirable constituents. Some such constituents may settle to the bottom of the bath due to relatively high density, while others may remain in suspension or float on the surface of the bath as dross.

When dross accumulates near the material being coated, the dross may adhere to the material being coated along with the coating material. Some constituents of dross may be excessively hard, brittle, and/or large. Thus, excessive dross may be undesirable as it may lead to a defective coating due to the presence of large, brittle, and/or excessively large particles.

In some circumstances, air lift pumps may be used for the management of dross. Such pumps may be used to extract dross from the surface of the bath to other segregated portions of the same bath or another bath entirely. In addition, or in the alternative, such pumps may be used to add coating material to the dross, thereby diluting the dross. However, some air lift pumps may exhibit unpredictable campaign life due to molten metal solidification in one or more portions of the pump. Therefore, it may be desirable to limit or otherwise avoid molten metal solidification within molten metal pumps such as air lift pumps.

### DESCRIPTION OF FIGURES

FIG. 1 depicts a front partial cross-sectional view of a coating portion of a steel processing line.

FIG. 2 depicts a side partial cross-sectional view of the coating portion of FIG. 1.

FIG. 3 depicts a perspective view of an introducer sheath of the coating portion of FIG. 1, the introducer sheath including a pair of molten metal pumps to remove dross from a hollow interior of the introducer sheath.

FIG. 4 depicts a side cross-sectional view of the introducer sheath of FIG. 3, the cross-section taken along line 4-4 of FIG. 3.

FIG. 5 depicts a perspective view of a molten metal pump of the pair of molten metal pumps of FIG. 3.

FIG. 6 depicts another perspective view of the molten metal pump of FIG. 5.

FIG. 7 depicts a partial top cross-sectional view of the molten metal pump of FIG. 5, the cross-section taken along line 7-7 of FIG. 5.

FIG. 8 depicts a partial side cross-sectional view of the molten metal pump of FIG. 5, the cross-section taken along line 8-8 of FIG. 6.

FIG. 9 depicts a plurality of plots of flow and pressure data comparing operation of test molten metal pumps of Examples 3 through 5.

FIG. 10 depicts another plurality of plots of flow and pressure data comparing operation of test molten metal pumps of Examples 3 through 5.

FIG. 11 depicts yet another plurality of plots of flow and pressure data comparing operation of test molten metal pumps of Examples 3 through 5.

### DETAILED DESCRIPTION

The need to move molten metal from one location to another may exist in a variety of material handling applications. Although examples are described herein in the context of moving molten metal in hot-dip coating of steel sheet, the teachings herein may be used in a variety of other alternative contexts. Indeed, the methods and apparatuses described herein may be readily applied in any context where movement of molten metal is desired. For instance, examples described herein may be applied in contexts where molten metal circulation or transport is desired such as in casting furnaces, smelting furnaces, nuclear reactors, and/or etc. In addition, or in the alternative, while molten metal is described herein as the principal agent being moved, it should be understood that the teachings herein may be readily applied to the movement of other materials such as polymers, molten salts, and/or etc.

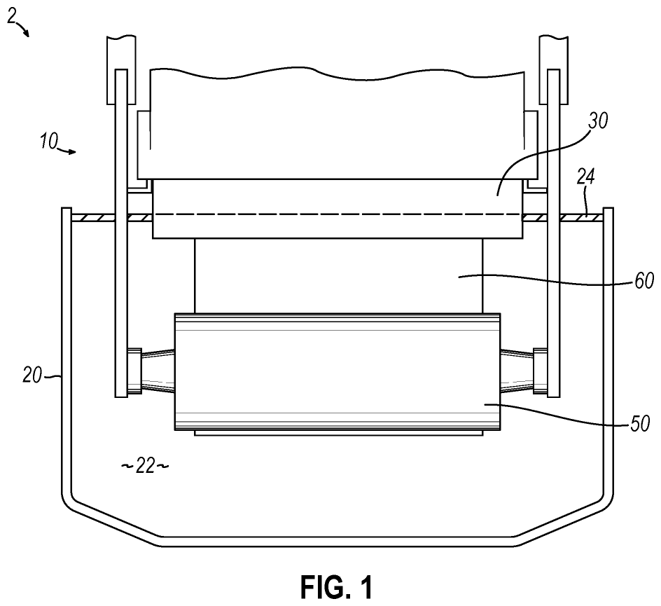

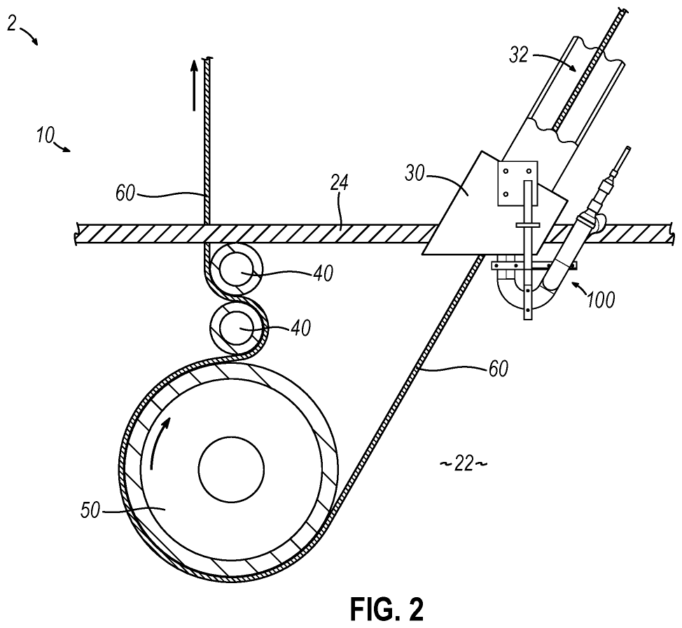

FIGS. 1 and 2 show an example of a coating portion (10) of a steel processing line (2), such as a continuous steel processing line. In the present version, coating portion (10) may be configured to perform a variety of coating operations. For instance, in some versions, coating portion (10) may be configured to apply a zinc-based coating (e.g., galvanizing, galvannealing). In other versions, coating portion (10) may be configured to apply an aluminum-based coating (e.g., aluminizing). Of course, coating portion (10) may be used to apply other suitable coatings in other versions.

As can be seen, coating portion (10) includes a dip tank (20) (also referred to as a molten metal pot or bath), an introducer sheath (30) (also referred to as a snout), one or more tensioner rolls (40) (also referred to as stabilizing rolls or support rolls), and a sink roll (50). As will be understood, coating portion (10) is generally configured to receive an elongate steel sheet (60) for coating of steel sheet (60). Dip tank (20) is defined by a solid wall configured to receive molten metal (22) (e.g., zinc, aluminum, zinc-aluminum alloys, etc.). In some versions, dip tank (20) may be lined with certain ceramic refractory materials that are particularly suited to contain molten metal (22).

The surface of molten metal (22) contained within dip tank (20) may include a dross layer (24). Dross layer (24) may form due to chemical reactions occurring between steel strip (60) and molten metal (22), between molten metal (22) and atmosphere, and between various combinations of steel strip (60), molten metal (22), and atmosphere. Although some amount of dross layer (24) may be permitted, an excessive amount of dross layer (24) is generally undesirable. For instance, dross layer (24) may accumulate within introducer sheath (30) adjacent to steel sheet (60). Such accumulation may result in the coating formed on steel sheet (60) being contaminated with undesirable constituents of dross layer (24) such as oxides. Thus, it may be desirable to control the amount of dross layer (24). In some versions, dross layer (24) may be controlled using a molten metal pump (100) described in greater detail below.

Introducer sheath (30) is configured to be partially submerged within molten metal (22) contained within dip tank (20). Accordingly, it should be understood that introducer sheath (30) generally provides an airtight seal around steel sheet (60) during entry into molten metal (22). Introducer sheath (30) includes a hollow interior (32) defined by the dimensions of introducer sheath (30) being greater than steel sheet (60). In some versions, hollow interior (32) may be filled entirely with an inert gas such as argon, nitrogen, carbon dioxide, and/or etc. to limit chemical reactions that may occur during entry of steel sheet (60) into molten metal (22). In addition, or in the alternative, the entire surface of molten metal (22) may be enclosed within an enclosure filled entirely with the inert gas.

One or more tensioner rolls (40) may be positioned relative to dip tank (20) to stabilize and tension steel sheet (60) as steel sheet (60) exits molten metal (22). Thus, it should be understood that tensioner rolls (40) are generally configured to promote stability of steel sheet (60) at various stages during the coating procedure. Although coating portion (10) of the present example is shown as including one group of two tensioner rolls (40), it should be understood that any suitable number and any suitable grouping of tensioner rolls (40) may be used. For instance, in some versions, coating portion (10) may be equipped with a group of one or more tensioner rolls (40) as steel sheet (60) both exits and enters molten metal (22). In other versions, tensioner rolls (40) or other similar rolls, may be included to change or alter the direction of steel sheet (60) as steel sheet (60) progresses through, and out of, molten metal (22). In still other versions, tensioner rolls (40) may be omitted entirely. Of course, various alternative configurations for tensioner rolls (40) will be apparent to those of ordinary skill in the art in view of the teachings herein.

As best seen in FIG. 2, sink roll (50) is positioned within molten metal (22) and is generally configured to redirect steel sheet (60) upwardly after steel sheet (60) has been submerged in molten metal (22). Although coating portion (10) of the present version is shown with only a single sink roll (50), it should be understood that in other versions any suitable number of sink rolls (50) may be used. For instance, in some versions, multiple sink rolls (50) may be used to increase the duration of time steel sheet (60) is disposed within molten metal (22) by directing steel sheet (60) through a more complex path within molten metal (22). Of course, various alternative configurations for sink roll (50) will be apparent to those of ordinary skill in the art in view of the teachings herein.

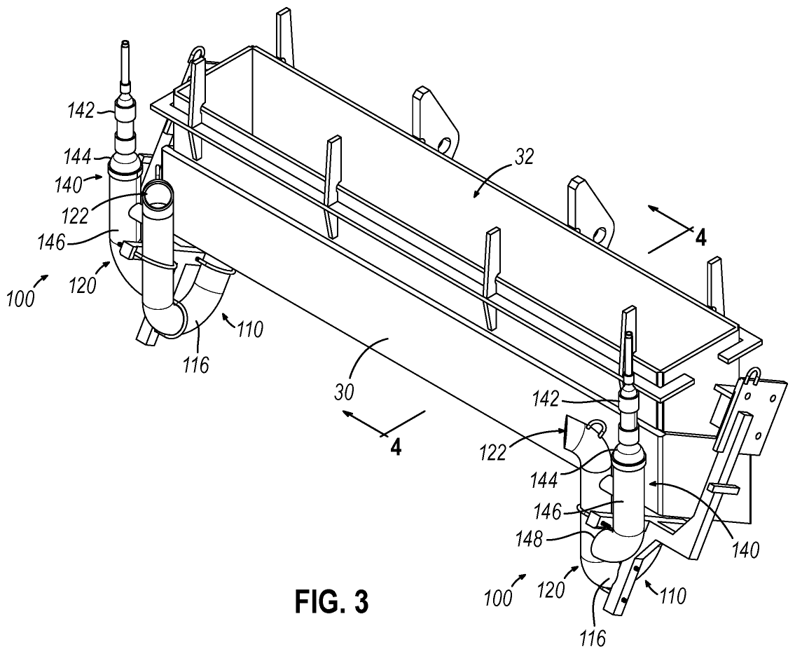

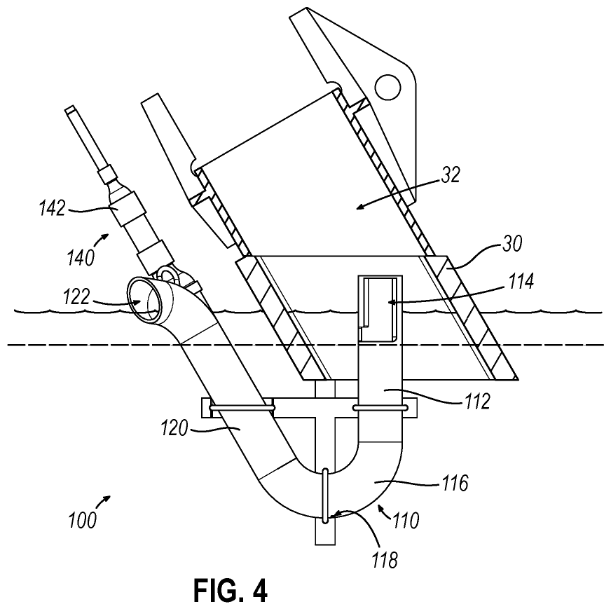

FIGS. 3 and 4 show an example of a molten metal pump (100) that may be readily used in combination with coating portion (10) described above. As can be seen, in the present configuration molten metal pump (100) is used in combination with introducer sheath (30). Specifically, two molten metal pumps (100) are disposed at opposite ends of introducer sheath (30) to communicate molten metal (22) from hollow interior (32) of introducer sheath (30) to the exterior of introducer sheath (30). As will be described in greater detail below, such communication of molten metal (22) may be beneficial to reduce the presence of dross layer (24) within hollow interior (32) of introducer sheath (30). Although two molten metal pumps (100) are used in the present version, any suitable number of molten metal pumps (100) may be used in other versions.

Molten metal pump (100) is generally configured to move molten metal (22) from one predetermined location to another predetermined location without any moving parts in contact with molten metal (22). In the present version, one or more molten metal pumps (100) may be positioned at various positions within dip tank (20) to extract or relocate dross relative to steel sheet (60). For instance, one or more molten metal pumps (100) may be positioned to be in communication with hollow interior (32) of introducer sheath (30) to extract excessive accumulations of dross layer (24) from introducer sheath (30). Of course, other suitable positions for one or more molten metal pumps (100) will be apparent to those of ordinary skill in the art in view of the teachings herein.

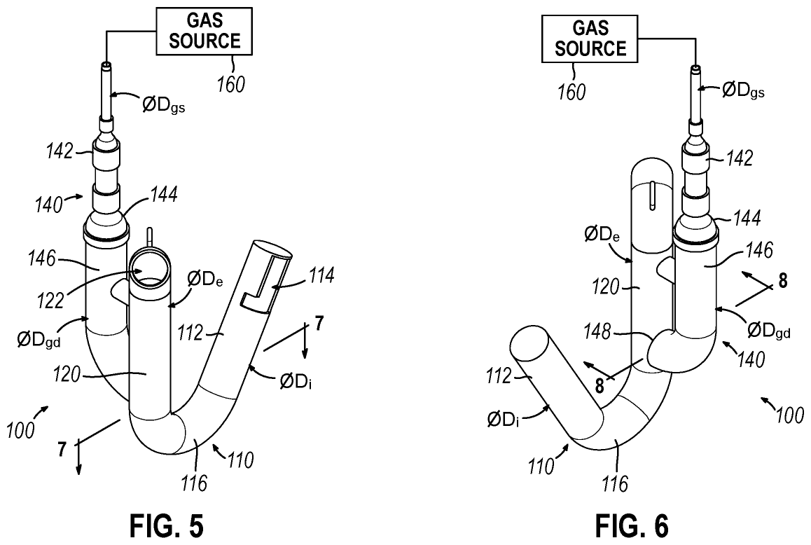

As best seen in FIGS. 4 and 5, molten metal pump (100) includes a transport conduit (110) and a gas conduit (140). Both transport conduit (110) and gas conduit (140) are integral in the present version but may be separate parts fixedly secured to each other in other versions. As will be understood, both transport conduit (110) and gas conduit (140) may directly contact molten metal (22) when in use.

Both transport conduit (110) and gas conduit (140) may be formed of one or more materials configured to withstand conditions associated with molten metal (22). As will be understood, suitable materials may be dependent on the particular molten metal (22) in use with molten metal pump (100). For instance, molten metal pump (100) may be used with molten zinc in some versions. The melting point of molten zinc is substantially lower than other metallic materials such as steel (e.g., about 787° F. vs about 2600° F.). Thus, various steels such as stainless steel may be used in some versions. In other version, particularly in versions used with higher melting point molten metal (22), suitable materials may include certain ceramic refractory materials configured to contain molten metal (22). Still other suitable materials as will be apparent to those of ordinary skill in the art in view of the teachings herein.

Transport conduit (110) includes an inlet portion (112), an exit portion (120), and a connecting portion (116) positioned between the inlet portion (112) and exit portion (120). Inlet portion (112) defines an elongate tubular structure in communication with an inlet port (114). Exit portion (120) similarly defines an elongate tubular structure in communication with an exit port (122).

Both inlet portion (112) and exit portion (120) together form a generally J-shaped configuration. In this configuration, inlet portion (112) oriented upwardly at about a 90° angle, while exit portion (120) oriented at about a 60° angle (relative to the horizontal plane). Alternatively, in some version the angle of exit portion (120) may be between 55° and 75°. The particular J-shaped configuration may be desirable in some versions to reduce the overall footprint of molten metal pump (100) in combination with introducer sheath (30). Additionally, the about 60° angle of exit portion (120) may be desirable to increase the flow velocity of molten metal (22) within molten metal pump (100). In other versions, inlet portion (112) and exit portion (120) may have a variety of alternative orientations. For instance, in some versions, both inlet portion (112) and exit portion (120) may be parallel and offset relative to each other.

Inlet port (114) and exit port (122) are generally aligned at a similar height generally corresponding to the level of dross layer (24), as will be described in greater detail below. In particular, inlet port (114) is positioned to correspond to be about the same level as dross layer (24) such that inlet port (114) may be configured to receive dross into inlet portion (112). Meanwhile, exit port (122) may be positioned slightly above the level of dross layer (24). As will be described in greater detail below, the slightly elevated position of exit port (122) may be desirable to facilitate communication of molten metal (22) out of exit port (122), while reducing the potential for backflow of molten metal (22). In other versions, inlet port (114) and exit port (122) may be substantially aligned along a common plane. In still other versions, exit port (122) may be positioned lower than inlet port (114).

Inlet port (114) and exit port (122) may be configured in a variety of shapes, provided each port (114, 122) is configured to communicate molten metal (22) as described herein. In the present version, inlet port (114) defines a generally square or rectangular-shaped opening in inlet portion (112) oriented vertically. Such a configuration may be desirable to complement the flow of fluid into inlet port (114). Meanwhile, exit port (112) defines a generally circular opening oriented at an angle. Suitable angles for exit port (112) may include 26° or 38° (relative to the vertical plane). In other versions, exit port (112) may be oriented at an angle between about 20° and about 40°. Such a configuration may likewise be desirable to complement the follow of fluid out of exit port (112). For instance, the circular and angled opening of exit port (112) may contribute to projection of molten metal (22) out of exit port (112) away from molten metal pump (100). In other versions, both inlet port (114) and/or exit port (122) may be in a rectangular, square, or circular shaped configuration.

Connecting portion (116) extends between inlet portion (112) and exit portion (120) opposite of inlet port (114) and exit port (122). Connecting portion (116) is generally curved to extend downwardly from inlet portion (112) and upwardly towards exit portion (120). The particular radius or shape of connecting portion (116) may be varied depending on a variety of factors such as the amount of offset between inlet portion (112) and exit portion (120), the particular configuration of equipment associated with molten metal pump (100) such as introducer sheath (30), the particular properties of the material being transported through molten metal pump (100), and/or etc.

As best seen in FIG. 4, connecting portion (116) may optionally include one or more drain openings (118). In the present version, drain openings (118) are configured to permit the flow of molten metal (22) out of connecting portion (116) during raising of introducer sheath (30). In some versions, drain openings (118) may be desirable to avoid freezing of molten metal (22) within transport conduit (110) when introducer sheath (30) is raised out of molten metal (22). Thus, drain openings (118) may permit continuing operation of molten metal pump (100), even after an event leading to raising of introducer sheath (30) (along with molten metal pump (100)) has occurred.

In versions that include one or more drain openings (118), various suitable drain opening (118) configurations may be used. For instance, in some versions, drain openings (118) may include three drain openings (118) arranged in a circular or triangular pattern. Drain openings (118) may further be oriented proximate the inflection point of connecting portion (116) to permit complete draining of transport conduit (110). For instance, during raising of introducer sheath (30), molten metal pump (100) may be positioned relative to introducer sheath (30) with drain openings (118) oriented at or above the bath line of molten metal (22). Molten metal (22) may then readily drain from transport conduit (110) under the force of gravity.

As best seen in FIG. 6, gas conduit (140) extends from a portion of transport conduit (110) and is generally configured to inject gas from a gas source (160) into at least a portion of transport conduit (110). Gas conduit (140) includes a gas supply conduit (142), a gas delivery conduit (146), and a neck (144) disposed between gas supply conduit (142) and gas delivery conduit (146). Gas supply conduit (142), gas delivery conduit (146), and neck (144) are configured as integral components in the present version. In addition, gas conduit (140) as a whole is integral within transport conduit (110) in the present version. Thus, gas conduit (140) may include a substantially similar material as transport conduit (110) described above such as carbon steel, stainless steel, ceramic refractory material, and/or etc. In other versions, one or more of gas supply conduit (142), gas delivery conduit (146), and/or neck (144) may be configured as a separate component fixedly or removably coupled to a given adjacent component.

Gas supply conduit (142) is in communication with gas source (160) either directly or indirectly via an intermediate tube or pipe. As will be described in greater detail below, gas supply conduit (142) generally defines a relatively small diameter relative to gas delivery conduit (146). Thus, neck (144) is configured as a transition to expand the diameter of gas conduit (140) from the diameter defined by gas supply conduit (142) to the diameter defined by gas delivery conduit (146). This configuration is generally desirable to transition the gas communicated by gas source (160) from having high velocity but low pressure to having low velocity but high pressure. In other words, the transition defined by neck (144) may be configured to generate a pressure front. Such a pressure front may result in a substantial increase in volumetric displacement of molten metal (22) through molten metal pump (100) per cycle of gas discharge. Such a pressure front may further facilitate sufficient velocity of molten metal (22) through molten metal pump (100) by creating a ramming effect without disturbing the meniscus of molten metal (22).

The particular position of neck (144) along the length of gas conduit (140) may have a particular relationship with other components of molten metal pump (100) such as exit port (122) or inlet port (114). For instance, neck (144) is positioned above at least a portion of both exit port (122) and inlet port (114) in the present version. In this configuration, neck (144) may be above the bath line of molten metal (22). This feature, in combination with one or more drain openings (118) described above, may be desirable to permit continued use of molten metal pump (100) even after raising of introducer sheath (30) out of molten metal (22). As will be described in greater detail below, the relationship between the diameter of gas conduit (140) submerged in molten metal (22) and the diameter of exit portion (120) can result in improved campaign life performance. Thus, the position of neck (144) above the bath line of molten metal (22) can relate to campaign life performance by controlling the particular diameter of gas conduit (140) submerged in molten metal (22).

Gas delivery conduit (146) is in communication with transport conduit (110) to communicate gas into the interior of transport conduit (110), thereby facilitating movement of molten metal therein. In particular, gas delivery conduit (146) intersects with transport conduit (110) at a portion of exit portion (120) to form a gas port (148). The particular point of intersection where gas port (148) is located in the present version is proximate the transition between connecting portion (116) and exit portion (120). Although a particular position of gas port (148) is shown, it should be understood that the position of gas port (148) may be varied in some versions. For instance, in some versions, gas delivery conduit (146) may intersect with exit portion (120) closer to exit port (122) and farther from connection portion (116). In other versions, gas delivery conduit (146) may intersect with exit portion (120) closer to connection portion (116) and farther from exit port (122). In still other versions, gas delivery conduit (146) may intersect with connection portion (116) rather than exit portion (120).

Regardless of the particular position of gas port (148), it is generally desirable for gas port (148) to be positioned between exit port (122) and the inflection point, or low point, of connecting portion (116). In particular, with this positioning of gas port (148), gas communicated by gas delivery conduit (146) will flow upwardly towards exit port (122), thereby driving molten metal flow into inlet port (114) and out of exit port (122). Thus, it should be appreciated that the direction of flow of molten metal may be controlled by the particular side the intersection of gas delivery conduit (146) is positioned relative to the inflection point of connecting portion (116). In some circumstances, it may be desirable to reverse the flow of molten metal through transport conduit (110) such as for use of molten metal pump (100) for dross dilution rather than extraction.

Gas source (160) is generally configured to communicate a gas composition of a specific pressure and temperature to gas conduit (140). The gas composition supplied may be an inert gas such as nitrogen. Other suitable inert gasses may include helium, neon, argon, combinations thereof (including nitrogen), and/or etc.

Gas source (160) may be configured to supply the gas composition at a variable pressure. Generally, the gas composition may be at a minimum pressure to achieve practical operation of molten metal pump (100). Minimizing the operating pressure of gas composition supplied by gas source (160) may be desirable to minimize molten metal solidification at the interface between the gas composition and the molten metal. In the present version, the gas pressure may be set to a nominal pressure of 6 pounds per square inch (psi) or less. In other versions, nominal pressure may be varied from 5 psi to 10 psi. As will be described in greater detail below, actual pressure of the gas composition may vary as the gas composition moves through molten metal pump (100).

The gas composition may also be heated using an electric or natural gas fired heating unit. Heating of the gas composition is generally desirable to contribute to a reduced temperature gradient at the interface between the gas composition and the molten metal (22). Thus, the gas composition may be heated to a temperature as close to the temperature of the molten metal as practical. In one version, the heating unit may be set to a nominal set point of 500° F. (260° C.), while actual temperatures may vary between about 500° F. and about 350° F. (176.7° C.) during use of the gas composition. In other versions, the heating unit may be set to a nominal set point greater than or equal to 500° F. In yet other versions, the temperature of the gas composition may be based on the temperature of the molten metal. For instance, in some versions, the temperature of the gas composition may be 470° F.±100° F. (e.g., between 370° and 570° F.) less than the temperature of the molten metal. In other words, if the molten metal is approximately 870° F., the gas composition may be approximately 400° F. or between 300° and 500° F. Of course, various suitable alternative temperatures may be used depending on the particular molten metal being used with molten metal pump (100).

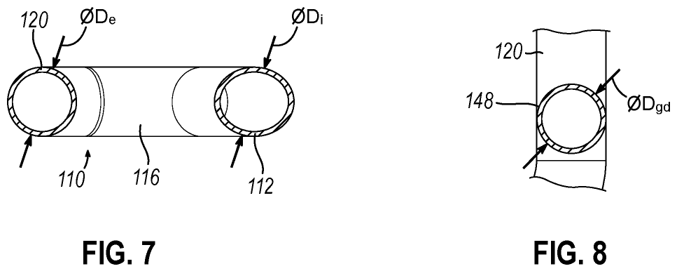

As best seen in FIGS. 5 through 8, inlet portion (112), exit portion (120), gas supply conduit (142) and gas delivery conduit (146) all define certain diameters that are related to each other. For instance, inlet portion (112) defines an inlet diameter (Dᵢ) that is substantially similar to an exit diameter (Dₑ). This equivalent relationship between inlet diameter (Dᵢ) and exit diameter (Dₑ) may be desirable to promote consistent flow of molten metal (22) through transport conduit (110). It should be understood that inlet diameter (Dᵢ) and exit diameter (Dₑ) may define a variety of suitable diameters, provided such diameters are substantially similar. By way of example only, both inlet diameter (Dᵢ) and exit diameter (Dₑ) may define a diameter of approximately 2 inches in some versions. In other versions, both inlet diameter (Dᵢ) and exit diameter (Dₑ) may define a diameter of approximately 4 inches or more. In still other versions, a suitable diameter for both inlet diameter (Dᵢ) and exit diameter (Dₑ) may be between approximately 2 inches and approximately 4 inches.

Gas conduit (140) defines a varying diameter at different portions thereof. For instance, gas supply conduit (142) defines a gas supply diameter (D_{gs}) that is less than a gas delivery diameter (D_{gd}) defined by gas delivery conduit (146). The increase in diameter from gas delivery diameter (D_{gd}) to gas supply diameter (D_{gs}) is generally configured to reduce the gas velocity flowing through gas delivery conduit (146), while increasing the pressure of gas flowing through gas delivery conduit (146). As will be described in greater detail below, decreasing operating velocity, while increasing operating pressure of gas delivery conduit (146) is generally desirable to provide a ramming effect to sufficiently move molten metal (22), while preserving the meniscus of molten metal (22) at the interface between the supplied gas and molten metal (22). Although a variety of relationships between gas supply diameter (D_{gs}) and gas delivery diameter (D_{gd}) may be used, in some versions, gas supply diameter (D_{gs}) may be approximately a quarter of the diameter of gas delivery diameter (D_{gd}).

The particular diameter of gas delivery diameter (D_{gd}) is related to inlet diameter (Dᵢ) and exit diameter (Dₑ). More specifically, gas delivery diameter (D_{gd}) is sized proportionally to exit diameter (Dₑ) to control the size of gas port (148). In some versions, gas delivery diameter (D_{gd}) may be no less than ½ exit diameter (Dₑ). Thus, in the version described above where exit diameter (Dₑ) is 4 inches, gas delivery diameter (D_{gd}) may be no less than 2 inches. In other versions, gas delivery diameter (D_{gd}) may be approximately equivalent to exit diameter (Dₑ). Thus, in the version described above where exit diameter (Dₑ) is 4 inches, gas delivery diameter (D_{gd}) may likewise be 4 inches. In still other versions, gas delivery diameter (D_{gd}) may be between ½ exit diameter (Dₑ) and approximately equivalent to exit diameter (Dₑ). Thus, in the version described above where exit diameter (Dₑ) is 4 inches, gas delivery diameter (D_{gd}) may be between 2 inches and 4 inches.

### EXAMPLE 1

A first test molten metal pump was prepared in accordance with at least some of the features of molten metal pump (100) described above. For instance, the first test molten metal pump included a transport conduit and a gas conduit generally similar to transport conduit (110) and gas conduit (140) described above.

In the first test molten metal pump, certain part dimensions were set to test the relationship of such dimensions to campaign life performance of molten metal pumps. Specifically, the transport conduit used a different diameter for the inlet portion relative to the exit portion, unlike inlet portion (112) and exit portion (120) described above. The particular dimensions used are summarized below in Table 1.

TABLE 1
First Test Molten Metal Pump—Dimensions

| Dimension | Measurement |
|---|---|
| Inlet Portion − Inner Diameter (in) | 3.88 |
| Inlet Port Size (in) | 3.88 |
| Exit Portion − Inner Diameter (in) | 5.76 |
| Gas Delivery Conduit − Inner Diameter (in) | 0.75 |
| Gas Port − Inner Diameter (in) | 0.75 |

As can be seen in Table 1 above, the ratio between the gas port diameter and the exit portion diameter was 0.13 or generally lower relative to the relationship discussed above with respect to molten metal pump (100).

The first test molten metal pump was then used in a galvanizing and galvannealing line to test campaign life performance. Three total tests were performed using the first test molten metal pump with an observed campaign life performance of 8, 16, and 17 days, respectively. Thus, the first test molten metal pump exhibited an average observed campaign life of about 14 days. This observed campaign life was considered to be no better than existing molten metal pumps.

### EXAMPLE 2

A second test molten metal pump was prepared in accordance with at least some the features of molten metal pump (100) described above. For instance, the second test molten metal pump included a transport conduit and a gas conduit generally similar to transport conduit (110) and gas conduit (140) described above.

In the second test molten metal pump, certain part dimensions were set to test the relationship of such dimensions to campaign life performance of molten metal pumps. Specifically, unlike the first test molten metal pump described above, the second test molten metal pump used a substantially similar diameter for the transport conduit in both the inlet portion and the exit portion. Additionally, unlike the first test molten metal pump described above, the second test molten metal pump used an increased gas delivery conduit diameter to increase the size of the gas port relative to the diameter of the exit portion of the transport conduit. The particular dimensions used are summarized below in Table 2.

TABLE 2
Second Test Molten Metal Pump—Dimensions

| Dimension | Measurement |
|---|---|
| Inlet Port Height Above Bath (in) | 3.75 |
| Inlet Port Depth Below Bath (in) | 2.75 |
| Inlet Portion − Inner Diameter (in) | 3.88 |
| Inlet Port Size (in) | 3.88 |
| Exit Port Height Above Bath (in) | 2.14 |
| Exit Portion − Inner Diameter (in) | 3.88 |
| Exit Port Angle (deg) | 26° |
| Gas Delivery Conduit − Inner Diameter (in) | 2.07 |
| Gas Port − Inner Diameter (in) | 2.07 |

The second test molten metal pump was then used in a commercial galvanizing and galvannealing line to test campaign life performance. Two total tests were performed using the second test molten metal pump with an observed campaign life performance of 18 days for both tests. Thus, the second test molten metal pump exhibited an improved campaign life relative to the first test molten metal pump. This improved campaign life was believed to be due to the relative increase of the ratio of the diameter the gas delivery conduit relative to the diameter of the exit portion of the transport conduit.

### EXAMPLE 3

A third test molten metal pump was prepared in accordance with at least some of the features of molten metal pump (100) described above. For instance, the third test molten metal pump included a transport conduit and a gas conduit generally similar to transport conduit (110) and gas conduit (140) described above.

In the third test molten metal pump, certain part dimensions were set to test the relationship of such dimensions to campaign life performance of molten metal pumps. Specifically, the third test molten metal pump was similar to the second test molten metal pump described above with respect to Example 2. For instance, as similarly described above, unlike the first test molten metal pump described above, the third test molten metal pump used a substantially similar diameter for the transport conduit in both the inlet portion and the exit portion. Additionally, unlike the first test molten metal pump described above, the third test molten metal pump used an increased gas delivery conduit diameter to increase the size of the gas port relative to the diameter of the exit portion of the transport conduit.

Relative to the second test molten metal pump, the third molten metal pump varied some dimensions and structures. For instance, the angle of exit port was increased. Additionally, the height of inlet port relative to the level of the bath was decreased. The particular dimensions used are summarized below in Table 3.

TABLE 3
Third Test Molten Metal Pump—Dimensions

| Dimension | Measurement |
|---|---|
| Inlet Port Height Above Bath (in) | 2.75 |
| Inlet Port Depth Below Bath (in) | 3.75 |
| Inlet Portion − Inner Diameter (in) | 3.88 |
| Inlet Port Size (in) | 3.88 |
| Exit Port Height Above Bath (in) | 2.53 |
| Exit Portion − Inner Diameter (in) | 3.88 |
| Exit Port Angle (deg) | 38° |
| Gas Delivery Conduit − Inner Diameter (in) | 2.07 |
| Gas Port − Inner Diameter (in) | 2.07 |

The third test molten metal pump was then used in a galvanizing and galvannealing line to test campaign life performance. Four total tests were performed using a version of the third test molten metal pump oriented on each side of the commercial introducer sheath. Thus, each individual test included two versions of the third test molten metal pump. This testing resulted in an observed campaign life performance of varying from a low of 13 days and a high of 22 days. The particular campaign life results are summarized below in Table 4, with the particular test number indicated as a whole number, and the side indicated with the letter “R” for right and the letter “L” for left (e.g., 1.R).

TABLE 4
Third Test Molten Metal Pump—Campaign Life

| Test No. | Campaign Life (Days) | Side of Sheath | Notes |
|---|---|---|---|
| 1.R | 13 | Right | |
| 1.L | 13 | Left | |
| 2.R | 15 | Right | |
| 2.L | 15 | Left | |
| 3.R | 14 | Right | |
| 3.L | 14 | Left | |
| 4.R | 22 | Right | Includes 2 idle days |
| 4.L | 22 | Left | Includes 2 idle days |

Thus, the third test molten metal pump exhibited an improved campaign life relative to the first test molten metal pump with an average 14-day campaign life. This improved campaign life was believed to be due to the relative increase of the ratio of the diameter the gas delivery conduit relative to the diameter of the exit portion of the transport conduit.

Unlike the testing associated with first and second test molten metal pumps described above, the testing associated with the third test molten metal pump included additional data collection related to observed pressures and flow rates. Such data was collected for the second, third, and fourth tests, but not the first test. The collected data is summarized below in Tables 5 through 7. Columns labeled “GA” and “GI” were used to identify whether the line was operating was operating for galvannealing (e.g., GA) or galvanizing (e.g., GI). A value of −5 is listed to indicate when operating in a particular mode.

TABLE 5
Test 2 - Summary of Pressure and Flow Data

| | | Right Side | | | | Left Side | | | |
|---|---|---|---|---|---|---|---|---|---|
| | | PSI | SCFM | | | PSI | SCFM | | |
| Date | Time | Effective | Flow | GA | GI | Effective | Flow | GA | GI |
| Dec. 15, 2021 | 2:36 PM | 10 | 7.5 | −5 | | 6 | 8 | −5 | |
| Dec. 16, 2021 | 9:32 AM | 10 | 7 | −5 | | 6 | 8 | −5 | |
| Dec. 17, 2021 | 8:41 AM | 9.4 | 15 | −5 | | 10 | 17.5 | −5 | |
| Dec. 17, 2021 | 9:22 AM | 9.4 | 15 | −5 | | 10 | 16 | −5 | |
| Dec. 17, 2021 | 11:10 AM | 12 | 14 | −5 | | 10 | 15 | −5 | |
| Dec. 17, 2021 | 2:06 PM | 10 | 4 | −5 | | 8 | 5 | −5 | |
| Dec. 20, 2021 | 8:02 AM | 12 | 9.5 | −5 | | 8.4 | 7.5 | −5 | |
| Dec. 20, 2021 | 11:12 AM | 12 | 10 | −5 | | 7 | 7.5 | −5 | |
| Dec. 22, 2021 | 7:00 AM | 12 | 10 | −5 | | 8.2 | 7.5 | −5 | |
| Dec. 23, 2021 | 8:22 AM | 11 | 10 | −5 | | 8 | 7.5 | −5 | |
| Dec. 28, 2021 | 12:58 PM | 9.9 | 7.5 | −5 | | 6 | 7.5 | −5 | |
| Dec. 29, 2021 | 8:07 AM | 9 | 7 | −5 | | 6.5 | 7.5 | −5 | |
| Dec. 29, 2021 | 8:48 AM | 8.6 | 5 | −5 | | 6.6 | 7.5 | −5 | |
| Dec. 29, 2021 | 9:50 AM | 9.6 | 5 | −5 | | 6.5 | 7.5 | −5 | |
| Dec. 29, 2021 | 2:00 PM | 8.2 | 6 | −5 | | 6.2 | 7 | −5 | |
| Dec. 30, 2021 | 8:40 AM | 6.8 | 3 | −5 | | 5.2 | 5 | −5 | |
| Dec. 30, 2021 | 11:24 AM | 6.4 | 3 | −5 | | 4.6 | 5 | −5 | |

TABLE 6
Test 3 - Summary of Pressure and Flow Data

| | | Right Side | | | | Left Side | | | |
|---|---|---|---|---|---|---|---|---|---|
| | | PSI | SCFM | | | PSI | SCFM | | |
| Date | Time | Effective | Flow | GA | GI | Effective | Flow | GA | GI |
| Jan. 7, 2022 | 7:30 AM | 9.7 | 7 | −5 | | 7.2 | 7 | −5 | |
| Jan. 7, 2022 | 10:25 AM | 9.7 | 7 | −5 | | 8.2 | 9 | −5 | |
| Jan. 7, 2022 | 1:30 PM | 9.8 | 7 | −5 | | 8.6 | 9 | −5 | |
| Jan. 10, 2022 | 8:00 AM | 11 | 5 | −5 | | 11 | 5 | −5 | |
| Jan. 10, 2022 | 2:00 PM | 8 | 1 | −5 | | 7 | 1 | −5 | |
| Jan. 13, 2022 | 7:00 AM | 8.8 | 15 | | −5 | 6.4 | 12.5 | | −5 |
| Jan. 13, 2022 | 8:30 AM | 12 | 15 | | −5 | 9 | 12.5 | | −5 |
| Jan. 13, 2022 | 2:45 PM | 12 | 15 | | −5 | 8 | 12.5 | | −5 |
| Jan. 14, 2022 | 6:55 AM | 12 | 15 | | −5 | 10 | 12.5 | | −5 |
| Jan. 20, 2022 | 7:50 AM | 9.8 | 16 | −5 | | 8.2 | 15 | −5 | |
| Jan. 20, 2022 | 2:15 PM | 11.6 | 14 | −5 | | 10 | 15 | −5 | |
| Jan. 21, 2022 | 7:15 AM | 6.5 | 5 | −5 | | 10 | 15 | −5 | |
| Jan. 21, 2022 | 8:30 AM | 8.5 | 15 | −5 | | 10 | 15 | −5 | |
| Jan. 21, 2022 | 1:41 PM | 6.4 | 6 | −5 | | 10 | 15 | −5 | |
| Jan. 21, 2022 | 1:41 PM | 6.4 | 6 | −5 | | 10 | 15 | −5 | |

TABLE 7
Test 4 - Summary of Pressure and Flow Data

| | | Right Side | | | | Left Side | | | |
|---|---|---|---|---|---|---|---|---|---|
| | | PSI | SCFM | | | PSI | SCFM | | |
| Date | Time | Effective | Flow | GA | GI | Effective | Flow | GA | GI |
| Jan. 24, 2022 | 12:52 PM | 5 | 20 | −5 | | 5 | 20 | −5 | |
| Jan. 24, 2022 | 2:23 PM | 12 | 18 | −5 | | 10 | 15 | −5 | |
| Jan. 24, 2022 | 2:23 PM | 12 | 18 | −5 | | 10 | 15 | −5 | |
| Jan. 26, 2022 | 11:00 AM | 8.2 | 9 | −5 | | 11 | 16 | −5 | |
| Jan. 26, 2022 | 11:00 AM | 8.2 | 9 | −5 | | 11 | 16 | −5 | |
| Jan. 27, 2022 | 12:52 PM | 5.8 | 5 | −5 | | 5.2 | 5 | −5 | |
| Jan. 27, 2022 | 12:52 PM | 5.8 | 5 | −5 | | 5.2 | 5 | −5 | |
| Jan. 28, 2022 | 9:42 AM | 14 | 20 | −5 | | 10 | 20 | −5 | |
| Jan. 28, 2022 | 1:11 PM | 14 | 20 | −5 | | 10 | 20 | −5 | |
| Jan. 31, 2022 | 8:49 AM | 10 | 14 | −5 | | 7 | 10 | −5 | |
| Jan. 31, 2022 | 8:49 AM | 10 | 14 | −5 | | 7 | 10 | −5 | |
| Feb. 1, 2022 | 10:01 AM | 10.5 | 14 | −5 | | 6 | 9 | −5 | |
| Feb. 1, 2022 | 1:34 PM | 11 | 15 | −5 | | 4 | 9 | −5 | |
| Feb. 2, 2022 | 7:45 AM | 9.5 | 14 | −5 | | 9 | 19 | −5 | |
| Feb. 2, 2022 | 7:45 AM | 9.5 | 14 | −5 | | 9 | 19 | −5 | |
| Feb. 7, 2022 | 7:52 AM | 6.5 | 8 | −5 | | 6.8 | 12 | −5 | |
| Feb. 9, 2022 | 11:33 AM | 8 | 10 | | −5 | 6.5 | 10 | | −5 |
| Feb. 9, 2022 | 11:33 AM | 8 | 10 | | −5 | 6.5 | 10 | | −5 |
| Feb. 11, 2022 | 10:48 AM | 6.8 | 7.5 | | −5 | 7 | 9 | | −5 |
| Feb. 11, 2022 | 10:48 AM | 6.8 | 7.5 | | −5 | 7 | 9 | | −5 |
| Feb. 14, 2022 | 1:00 PM | 5 | 1 | | −5 | 2 | 5 | | −5 |
| Feb. 15, 2022 | 9:24 AM | 4.2 | 1 | | −5 | 1.8 | 3 | | −5 |

In addition to data related to observed pressures and flow rates, data was also taken related to observed temperature. In particular, observed temperature was measured at the discharge from the gas source. This discharge was positioned about 25 to 30 feet from the test molten metal pump. The observed temperatures are shown below for Tests 2, 3, and 4 in Tables 8, 9, and 10, respectively.

TABLE 8
Test 2—Observed Temperatures

| Right Side | | | Left Side | | |
|---|---|---|---|---|---|
| | | Temp | | | Temp |
| Date | Time | ° F. | Date | Time | ° F. |
| 12/15/21 | 2:36 PM | 375 | 12/15/21 | 2:36 PM | 300 |
| 12/17/21 | 9:22 AM | 200 | 12/16/21 | 9:32 AM | 300 |
| 12/17/21 | 11:10 AM | 420 | 12/17/21 | 8:41 AM | 300 |
| 12/17/21 | 2:06 PM | 395 | 12/17/21 | 9:22 AM | 350 |
| 12/20/21 | 8:02 AM | 400 | 12/17/21 | 11:10 AM | 335 |
| 12/20/21 | 11:12 AM | 400 | 12/17/21 | 2:06 PM | 300 |
| 12/22/21 | 7:00 AM | 400 | 12/20/21 | 8:02 AM | 335 |
| 12/23/21 | 8:22 AM | 395 | 12/20/21 | 11:12 AM | 340 |
| 12/28/21 | 12:58 PM | 412.5 | 12/22/21 | 7:00 AM | 345 |
| 12/29/21 | 8:07 AM | 385 | 12/23/21 | 8:22 AM | 345 |
| 12/29/21 | 8:48 AM | 385 | 12/28/21 | 12:58 PM | 350 |
| 12/29/21 | 9:50 AM | 395 | 12/29/21 | 8:07 AM | 345 |
| 12/29/21 | 2:00 PM | 365 | 12/29/21 | 8:48 AM | 348 |
| 12/30/21 | 8:40 AM | 310 | 12/29/21 | 9:50 AM | 346 |
| 12/30/21 | 11:24 AM | 290 | 12/29/21 | 2:00 PM | 342 |
| | | | 12/30/21 | 8:40 AM | 300 |
| | | | 12/30/21 | 11:24 AM | 285 |

TABLE 9
Test 3 - Observed Temperatures

| Right Side | | | Left Side | | |
|---|---|---|---|---|---|
| | | Temp | | | Temp |
| Date | Time | ° F. | Date | Time | ° F. |
| Jan. 7, 2022 | 7:30 AM | 400 | Jan. 7, 2022 | 7:30 AM | 325 |
| Jan. 7, 2022 | 10:25 AM | 390 | Jan. 7, 2022 | 10:25 AM | 345 |
| Jan. 7, 2022 | 1:30 PM | 390 | Jan. 7, 2022 | 1:30 PM | 345 |
| Jan. 10, 2022 | 8:00 AM | 390 | Jan. 10, 2022 | 8:00 AM | 390 |
| Jan. 10, 2022 | 2:00 PM | 335 | Jan. 10, 2022 | 2:00 PM | 275 |
| Jan. 13, 2022 | 7:00 AM | 200 | Jan. 13, 2022 | 7:00 AM | 175 |
| Jan. 13, 2022 | 8:30 AM | 460 | Jan. 13, 2022 | 8:30 AM | 355 |
| Jan. 13, 2022 | 2:45 PM | 465 | Jan. 13, 2022 | 2:45 PM | 360 |
| Jan. 14, 2022 | 6:55 AM | 465 | Jan. 14, 2022 | 6:55 AM | 360 |
| Jan. 20, 2022 | 7:50 AM | 405 | Jan. 20, 2022 | 7:50 AM | 345 |
| Jan. 20, 2022 | 2:15 PM | 470 | Jan. 20, 2022 | 2:15 PM | 370 |
| Jan. 21, 2022 | 7:15 AM | 365 | Jan. 21, 2022 | 7:15 AM | 375 |
| Jan. 21, 2022 | 8:30 AM | 380 | Jan. 21, 2022 | 8:30 AM | 375 |
| Jan. 21, 2022 | 1:41 PM | 365 | Jan. 21, 2022 | 1:41 PM | 370 |
| Jan. 21, 2022 | 1:41 PM | 365 | Jan. 21, 2022 | 1:41 PM | 370 |

TABLE 10
Test 4 - Observed Temperatures

| Right Side | | | Left Side | | |
|---|---|---|---|---|---|
| | | Temp | | | Temp |
| Date | Time | ° F. | Date | Time | ° F. |
| Jan. 24, 2022 | 2:23 PM | 475 | Jan. 24 2022 | 2:23 PM | 360 |
| Jan. 24, 2022 | 2:23 PM | 475 | Jan. 24 2022 | 2:23 PM | 360 |
| Jan. 26, 2022 | 11:00 AM | 415 | Jan. 26 2022 | 11:00 AM | 360 |
| Jan. 26, 2022 | 11:00 AM | 415 | Jan. 26 2022 | 11:00 AM | 360 |
| Jan. 27, 2022 | 12:52 PM | 340 | Jan. 27 2022 | 12:52 PM | 300 |
| Jan. 27, 2022 | 12:52 PM | 340 | Jan. 27 2022 | 12:52 PM | 300 |
| Jan. 28, 2022 | 9:42 AM | 490 | Jan. 28 2022 | 9:42 AM | 355 |
| Jan. 28, 2022 | 1:11 PM | 490 | Jan. 28 2022 | 1:11 PM | 355 |
| Jan. 31, 2022 | 8:49 AM | 465 | Jan. 31 2022 | 8:49 AM | 340 |
| Jan. 31, 2022 | 8:49 AM | 465 | Jan. 31 2022 | 8:49 AM | 340 |
| Feb. 1, 2022 | 10:01 AM | 465 | Feb. 1 2022 | 10:01 AM | 340 |
| Feb. 1, 2022 | 1:34 PM | 470 | Feb. 1 2022 | 1:34 PM | 355 |
| Feb. 2, 2022 | 7:45 AM | 465 | Feb. 2 2022 | 7:45 AM | 350 |
| Feb. 2, 2022 | 7:45 AM | 465 | Feb. 2 2022 | 7:45 AM | 350 |
| Feb. 7, 2022 | 7:52 AM | 425 | Feb. 7 2022 | 7:52 AM | 355 |
| Feb. 9, 2022 | 11:33 AM | 435 | Feb. 9 2022 | 11:33 AM | 350 |
| Feb. 9, 2022 | 11:33 AM | 435 | Feb. 9 2022 | 11:33 AM | 350 |
| Feb. 11, 2022 | 10:48 AM | 410 | Feb. 11 2022 | 10:48 AM | 340 |
| Feb. 11, 2022 | 10:48 AM | 410 | Feb. 11 2022 | 10:48 AM | 340 |
| Feb. 14, 2022 | 1:00 PM | 290 | Feb. 14 2022 | 1:00 PM | 235 |
| Feb. 15, 2022 | 9:24 AM | 185 | Feb. 15 2022 | 9:24 AM | 150 |

As can be seen, observed temperature varied during operation between a high of 490° F. to and a low of 150° F. The average observed temperature was about 364° F.

### EXAMPLE 4

A fourth test molten metal pump was prepared in accordance with at least some the features of molten metal pump (100) described above. For instance, the fourth test molten metal pump included a transport conduit and a gas conduit generally similar to transport conduit (110) and gas conduit (140) described above.

In the fourth test molten metal pump, certain part dimensions were set to test the relationship of such dimensions to campaign life performance of molten metal pumps. Specifically, the fourth test molten metal pump was similar to the third test molten metal pump described above with respect to Example 3. For instance, as similarly described above, unlike the first test molten metal pump described above, the fourth test molten metal pump used a substantially similar diameter for the transport conduit in both the inlet portion and the exit portion. Additionally, unlike the first test molten metal pump described above, the fourth test molten metal pump used an increased gas delivery conduit diameter to increase the size of the gas port relative to the diameter of the exit portion of the transport conduit.

Relative to the third test molten metal pump, the fourth molten metal pump varied some dimensions and structures. For instance, an insulator was added between the gas source and the gas conduit. The size of the inlet port was decreased from 3.88 inches to 2.46 inches due to concerns for the potential for backflow of molten metal at the end of life for the test molten metal pump and potential adherence and/or buildup of molten metal to the interior walls of the sheath. Additionally, some fixturing structures that connected the fourth test molten metal pump to the introducer sheath were modified. The particular dimensions used are summarized below in Table 11.

TABLE 11
Fourth Test Molten Metal Pump - Dimensions

| Dimension | Measurement |
|---|---|
| Inlet Port Height Above Bath (in) | 2.75 |
| Inlet Port Depth Below Bath (in) | 3.75 |
| Inlet Portion - Inner Diameter (in) | 3.88 |
| Inlet Port Size (in) | 2.46 |
| Exit Port Height Above Bath (in) | 2.53 |
| Exit Portion - Inner Diameter (in) | 3.88 |
| Exit Port Angle (deg) | 38° |
| Gas Delivery Conduit - Inner Diameter (in) | 2.07 |
| Gas Port - Inner Diameter (in) | 2.07 |

The fourth test molten metal pump was then used in a galvanizing and galvannealing line to test campaign life performance. Four total tests were performed using a substantially similar version of the fourth test molten metal pump oriented on each side of the introducer sheath. Thus, each individual test included two substantially similar versions of the fourth test molten metal pump. This testing resulted in an observed campaign life performance varying from a low of 16 days and a high of 20 days. Incidentally, in one of the tests one fourth test molten metal pump was removed early at 8 days due to concerns related to introducer sheath buildup. The particular campaign life results are summarized below in Table 12, with the particular test number indicated as a whole number, and the side indicated with the letter “R” for right and the letter “L” for left (e.g., 1.R).

TABLE 12
Fourth Test Molten Metal Pump - Campaign Life

| Test No. | Campaign Life (Days) | Side of Sheath | Notes |
|---|---|---|---|
| 1.R | 16 | Right | |
| 1.L | 16 | Left | |
| 2.R | 17 | Right | |
| 2.L | 17 | Left | |
| 3.R | 20 | Right | |
| 3.L | 19 | Left | |
| 4.R | 18 | Right | |
| 4.L | 8 | Left | Removed Early |

Thus, the fourth test molten metal pump exhibited an improved campaign life relative to the first test molten metal pump with an average 17.5-day campaign life (excluding test where a pump was removed early). This improved campaign life was believed to be due to the relative increase of the ratio of the diameter the gas delivery conduit relative to the diameter of the exit portion of the transport conduit.

For test number 4.L, the test molten metal pump was removed early. The removal was performed due to observation of buildup on the introducer sheath. Subsequent investigation concluded that the buildup was related furnace pressure oscillations (e.g., pressure bottoming out) and to wet nitrogen systems within the introducer sheath and not due to test molten metal pump performance.

Unlike the testing associated with first and second test molten metal pumps described above, the testing associated with the fourth test molten metal pump included additional data collection related to observed pressures and flow rates. Such data was collected for all tests. The collected data is summarized below in Tables 13 through 16. Columns labeled “GA” and “GI” were used to identify whether the line was operating was operating for galvannealing (e.g., GA) or galvanizing (e.g., GI). A value of −5 is listed to indicate when operating in a particular mode.

TABLE 13
Test 1 - Summary of Pressure and Flow Data

| Right Side | | | | | | Left Side | | | | | |
|---|---|---|---|---|---|---|---|---|---|---|---|
| | | PSI | SCFM | | | | | PSI | SCFM | | |
| Date | Time | Effective | Flow | GA | GI | Date | Time | Effective | Flow | GA | GI |
| Feb. 21, 2022 | 8:30 AM | 12.5 | 20 | −5 | | Feb. 21, 2022 | 8:30 AM | 10 | 25 | −5 | |
| Feb. 22, 2022 | 10:40 AM | 11 | 20 | −5 | | Feb. 22, 2022 | 10:40 AM | 3 | 15 | −5 | |
| Feb. 23, 2022 | 9:00 AM | 7 | 10 | −5 | | Feb. 23, 2022 | 9:00 AM | 4 | 10 | −5 | |
| Feb. 24, 2022 | 9:42 AM | 6 | 5 | −5 | | Feb. 24, 2022 | 9:47 AM | 3.8 | 10 | −5 | |
| Feb. 24, 2022 | 2:16 PM | 6.4 | 6 | −5 | | Feb. 24, 2022 | 2:16 PM | 3.8 | 10 | −5 | |
| Feb. 25, 2022 | 9:00 AM | 6.8 | 7 | −5 | | Feb. 25, 2022 | 9:00 AM | 4.6 | 10 | −5 | |
| Feb. 25, 2022 | 1:52 PM | 9.4 | 10 | −5 | | Feb. 25, 2022 | 1:52 PM | 4.8 | 15 | −5 | |
| Feb. 25, 2022 | 2:23 PM | 10.6 | 17 | −5 | | Feb. 25, 2022 | 2:23 PM | 5.5 | 14 | −5 | |
| Feb. 28, 2022 | 9:00 AM | 6.4 | 6 | −5 | | Feb. 28, 2022 | 9:00 AM | 1.6 | 7 | −5 | |
| Mar. 1, 2022 | 8:15 AM | 6 | 6 | −5 | | Mar. 1, 2022 | 8:15 AM | 0.2 | 6 | −5 | |
| Mar. 3, 2022 | 11:58 AM | 5 | 4 | −5 | | Mar. 3, 2022 | 11:58 AM | 0 | 0 | −5 | |

TABLE 14
Test 2 - Summary of Pressure and Flow Data

| Right Side | | | | | | Left Side | | | | | |
|---|---|---|---|---|---|---|---|---|---|---|---|
| | | PSI | SCFM | | | | | PSI | SCFM | | |
| Date | Time | Effective | Flow | GA | GI | Date | Time | Effective | Flow | GA | GI |
| Mar. 4, 2022 | 2:00 PM | 10.8 | 19 | −5 | | Mar. 4, 2022 | 2:00 PM | 0.5 | 12 | −5 | |
| Mar. 4, 2022 | 2:00 PM | 10.8 | 19 | −5 | | Mar. 4, 2022 | 2:00 PM | 0.5 | 12 | −5 | |
| Mar. 9, 2022 | 10:00 AM | 13 | 20 | −5 | | Mar. 9, 2022 | 10:00 AM | 4.5 | 9 | −5 | |
| Mar. 11, 2022 | 9:30 AM | 11 | 18 | | −5 | Mar. 11, 2022 | 9:30 AM | 4 | 9 | | −5 |
| Mar. 14, 2022 | 10:37 AM | 12 | 16 | | −5 | Mar. 14, 2022 | 10:37 AM | 3.8 | 8 | | −5 |
| Mar. 15, 2022 | 9:21 AM | 11 | 16 | | −5 | Mar. 15, 2022 | 9:21 AM | 9.5 | 24 | | −5 |
| Mar. 20, 2021 | 5:00 AM | 15 | 7 | | −5 | Mar. 20, 2021 | 5:00 AM | 12.5 | 4 | | −5 |
| Mar. 20, 2022 | 5:00 PM | 15 | 10 | | −5 | Mar. 20, 2022 | 5:00 PM | 9.5 | 5 | | −5 |
| Mar. 21, 2022 | 5:00 AM | 15 | 10 | | −5 | Mar. 21, 2022 | 5:00 AM | 11.5 | 2 | | −5 |

TABLE 15
Test 3 - Summary of Pressure and Flow Data

| Right Side | | | | | | Left Side | | | | | |
|---|---|---|---|---|---|---|---|---|---|---|---|
| | | PSI | SCFM | | | | | PSI | SCFM | | |
| Date | Time | Effective | Flow | GA | GI | Date | Time | Effective | Flow | GA | GI |
| Mar. 21, 2022 | 2:48 PM | 10 | 7.5 | −5 | | Mar. 21, 2022 | 2:48 PM | 8 | 7 | −5 | |
| Mar. 22, 2022 | 10:44 AM | 9.5 | 7 | −5 | | Mar. 22, 2022 | 10:44 AM | 9 | 7 | −5 | |
| Mar. 24, 2022 | 11:23 AM | 8.5 | 6 | −5 | | Mar. 24, 2022 | 11:23 AM | 8.5 | 6 | −5 | |
| Mar. 25, 2022 | 1:00 PM | 5.5 | 6 | −5 | | Mar. 25, 2022 | 1:00 PM | 7.5 | 7.5 | −5 | |
| Mar. 28, 2022 | 2:20 PM | 5.5 | 6 | −5 | | Mar. 28, 2022 | 2:20 PM | 7.25 | 7 | −5 | |
| Mar. 29, 2022 | 8:16 AM | 5.25 | 5.5 | −5 | | Mar. 29, 2022 | 8:16 AM | 7.25 | 6.5 | −5 | |
| Mar. 30, 2022 | 1:11 PM | 7.75 | 7 | −5 | | Mar. 30, 2022 | 1:11 PM | 6.75 | 6.5 | −5 | |
| Apr. 4, 2022 | 10:18 AM | 6 | 3 | −5 | | Apr. 4, 2022 | 10:18 AM | 6.5 | 6.5 | −5 | |
| Apr. 4, 2022 | 10:18 AM | 6 | 3 | −5 | | Apr. 4, 2022 | 10:18 AM | 6.5 | 6.5 | −5 | |
| Apr. 5, 2022 | 2:18 PM | 5.5 | 2.9 | −5 | | Apr. 5, 2022 | 2:18 PM | 6 | 7.5 | −5 | |
| Apr. 6, 2022 | 7:50 AM | 6 | 3 | −5 | | Apr. 6, 2022 | 7:50 AM | 7.5 | 7.5 | −5 | |
| Apr. 7, 2022 | 10:23 AM | 6.5 | 4 | −5 | | Apr. 7, 2022 | 10:23 AM | 6 | 6 | −5 | |
| Apr. 8, 2022 | 1:40 PM | 5 | 2 | −5 | | Apr. 8, 2022 | 1:40 PM | 5.5 | 5 | −5 | |
| Apr. 9, 2022 | 5:00 AM | 3 | 5 | −5 | | | | | | | |
| Apr. 9, 2022 | 5:00 PM | 3 | 5 | −5 | | | | | | | |
| Apr. 10, 2022 | 5:00 AM | 3 | 5 | −5 | | | | | | | |

TABLE 16
Test 4 - Summary of Pressure and Flow Data

| Right Side | | | | | | Left Side | | | | | |
|---|---|---|---|---|---|---|---|---|---|---|---|
| | | PSI | SCFM | | | | | PSI | SCFM | | |
| Date | Time | Effective | Flow | GA | GI | Date | Time | Effective | Flow | GA | GI |
| Apr. 20, 2022 | 6:40 AM | 7 | 3 | | −5 | Apr. 20, 2022 | 6:40 AM | 6.5 | 4 | | −5 |
| Apr. 20, 2022 | 3:00 PM | 11 | 6 | | −5 | Apr. 20, 2022 | 3:00 PM | 11 | 7 | | −5 |
| Apr. 21, 2022 | 9:40 AM | 11 | 6 | | −5 | Apr. 21, 2022 | 9:40 AM | 9 | 7 | | −5 |
| Apr. 22, 2022 | 8:50 AM | 11 | 6 | | −5 | Apr. 22, 2022 | 8:50 AM | 9 | 6 | | −5 |
| Apr. 22, 2022 | 2:54 PM | 10.5 | 6 | | −5 | Apr. 22, 2022 | 2:54 PM | 9 | 6 | | −5 |
| Apr. 25, 2022 | 6:34 AM | 8 | 7 | −5 | | Apr. 25, 2022 | 6:34 AM | 9 | 8.5 | −5 | |
| Apr. 25, 2022 | 12:07 PM | 7 | 7 | −5 | | Apr. 25, 2022 | 12:07 PM | 8 | 5 | −5 | |
| Apr. 26, 2022 | 7:14 AM | 7.5 | 7 | −5 | | Apr. 26, 2022 | 7:14 AM | 8 | 6 | −5 | |
| Apr. 27, 2022 | 7:15 AM | 7 | 7 | −5 | | Apr. 27, 2022 | 7:15 AM | 10.5 | 8 | −5 | |
| Apr. 27, 2022 | 12:40 PM | 9 | 9 | −5 | | | | | | | |
| May 2, 2022 | 11:22 AM | 9 | 6 | −5 | | | | | | | |
| May 2, 2022 | 11:22 AM | 9 | 6 | −5 | | | | | | | |
| May 2, 2022 | 2:40 PM | 8 | 5.5 | −5 | | | | | | | |
| May 3, 2022 | 12:10 PM | 8 | 6 | −5 | | | | | | | |
| May 4, 2022 | 10:40 AM | 7.5 | 6 | −5 | | | | | | | |
| May 5, 2022 | 10:25 AM | 6 | 3 | −5 | | | | | | | |
| May 6, 2022 | 12:56 PM | 5 | 1 | −5 | | | | | | | |

In addition to data related to observed pressures and flow rates, data was also taken related to observed temperature. In particular, observed temperature was measured at the discharge from the gas source. This discharge was positioned about 25 to 30 feet from the test molten metal pump. The observed temperatures are shown below for Tests 1, 2, 3, and 4 in Tables 17 through 20.

TABLE 17
Test 1 - Observed Temperatures

| Right Side | | | Left Side | | |
|---|---|---|---|---|---|
| | | Temp | | | Temp |
| Date | Time | ° F. | Date | Time | ° F. |
| Feb. 21, 2022 | 8:30 AM | 495 | Feb. 21, 2022 | 8:30 AM | 350 |
| Feb. 22, 2022 | 10:40 AM | 500 | Feb. 22, 2022 | 10:40 AM | 350 |
| Feb. 23, 2022 | 9:00 AM | 480 | Feb. 23, 2022 | 9:00 AM | 335 |
| Feb. 24, 2022 | 9:42 AM | 375 | Feb. 24, 2022 | 9:47 AM | 345 |
| Feb. 24, 2022 | 2:16 PM | 375 | Feb. 24, 2022 | 2:16 PM | 345 |
| Feb. 25, 2022 | 9:00 AM | 390 | Feb. 25, 2022 | 9:00 AM | 350 |
| Feb. 25, 2022 | 1:52 PM | 440 | Feb. 25, 2022 | 1:52 PM | 350 |
| Feb. 25, 2022 | 2:23 PM | 450 | Feb. 25, 2022 | 2:23 PM | 350 |
| Feb. 28, 2022 | 9:00 AM | 380 | Feb. 28, 2022 | 9:00 AM | 305 |
| Mar. 1, 2022 | 8:15 AM | 385 | Mar. 1, 2022 | 8:15 AM | 300 |
| Mar. 3, 2022 | 11:58 AM | 330 | Mar. 3, 2022 | 11:58 AM | 105 |

TABLE 18
Test 2 - Observed Temperatures

| Right Side | | | Left Side | | |
|---|---|---|---|---|---|
| | | Temp | | | Temp |
| Date | Time | º F. | Date | Time | ° F. |
| Mar. 4, 2022 | 2:00 PM | 215 | Mar. 4, 2022 | 2:00 PM | 335 |
| Mar. 4, 2022 | 2:00 PM | 215 | Mar. 4, 2022 | 2:00 PM | 335 |
| Mar. 9, 2022 | 10:00 AM | 490 | Mar. 9, 2022 | 10:00 AM | 355 |
| Mar. 11, 2022 | 9:30 AM | 495 | Mar. 11, 2022 | 9:30 AM | 350 |
| Mar. 14, 2022 | 10:37 AM | 485 | Mar. 14, 2022 | 10:37 AM | 345 |
| Mar. 15, 2022 | 9:21 AM | 485 | Mar. 15, 2022 | 9:21 AM | 350 |

TABLE 19
Test 3 - Observed Temperatures

| Right Side | | | Left Side | | |
|---|---|---|---|---|---|
| | | Temp | | | Temp |
| Date | Time | º F. | Date | Time | º F. |
| Mar. 21, 2022 | 2:48 PM | 430 | Mar. 21, 2022 | 2:48 PM | 350 |
| Mar. 22, 2022 | 10:44 AM | 430 | Mar. 22, 2022 | 10:44 AM | 350 |
| Mar. 24, 2022 | 11:23 AM | 405 | Mar. 24, 2022 | 11:23 AM | 330 |
| Mar. 25, 2022 | 1:00 PM | 355 | Mar. 25, 2022 | 1:00 PM | 310 |
| Mar. 28, 2022 | 2:20 PM | 375 | Mar. 28, 2022 | 2:20 PM | 310 |
| Mar. 29, 2022 | 8:16 AM | 355 | Mar. 29, 2022 | 8:16 AM | 300 |
| Mar. 30, 2022 | 1:11 PM | 400 | Mar. 30, 2022 | 1:11 PM | 305 |
| Apr. 4, 2022 | 10:18 AM | 315 | Apr. 4, 2022 | 10:18 AM | 305 |
| Apr. 4, 2022 | 10:18 AM | 315 | Apr. 4, 2022 | 10:18 AM | 305 |
| Apr. 5, 2022 | 2:18 PM | 280 | Apr. 5, 2022 | 2:18 PM | 290 |
| Apr. 6, 2022 | 7:50 AM | 300 | Apr. 6, 2022 | 7:50 AM | 295 |
| Apr. 7, 2022 | 10:23 AM | 330 | Apr. 7, 2022 | 10:23 AM | 250 |
| Apr. 8, 2022 | 1:40 PM | 250 | Apr. 8, 2022 | 1:40 PM | 200 |

TABLE 20
Test 4 - Observed Temperatures

| Right Side | | | Left Side | | |
|---|---|---|---|---|---|
| | | Temp | | | Temp |
| Date | Time | º F. | Date | Time | ° F. |
| Apr. 20, 2022 | 6:40 AM | 60 | Apr. 20, 2022 | 6:40 AM | 60 |
| Apr. 20, 2022 | 3:00 PM | 390 | Apr. 20, 2022 | 3:00 PM | 325 |
| Apr. 21, 2022 | 9:40 AM | 400 | Apr. 21, 2022 | 9:40 AM | 325 |
| Apr. 22, 2022 | 8:50 AM | 400 | Apr. 22, 2022 | 8:50 AM | 325 |
| Apr. 22, 2022 | 2:54 PM | 400 | Apr. 22, 2022 | 2:54 PM | 315 |
| Apr. 25, 2022 | 6:34 AM | 125 | Apr. 25, 2022 | 6:34 AM | 325 |
| Apr. 25, 2022 | 12:07 PM | 85 | Apr. 25, 2022 | 12:07 PM | 285 |
| Apr. 26, 2022 | 7:14 AM | 75 | Apr. 26, 2022 | 7:14 AM | 300 |
| Apr. 27, 2022 | 7:15 AM | 65 | Apr. 27, 2022 | 7:15 AM | 385 |
| Apr. 27, 2022 | 12:40 PM | 70 | | | |
| May 2, 2022 | 11:22 AM | 285 | | | |
| May 2, 2022 | 11:22 AM | 285 | | | |
| May 2, 2022 | 2:40 PM | 155 | | | |
| May 3, 2022 | 12:10 PM | 280 | | | |
| May 4, 2022 | 10:40 AM | 275 | | | |
| May 5, 2022 | 10:25 AM | 240 | | | |
| May 6, 2022 | 12:56 PM | 180 | | | |

As can be seen, observed temperature varied during operation between a high of 500° F. to and a low of 60° F. The average observed temperature was about 319° F.

### EXAMPLE 5

A fifth test molten metal pump was prepared in accordance with at least some the features of molten metal pump (100) described above. For instance, the fifth test molten metal pump included a transport conduit and a gas conduit generally similar to transport conduit (110) and gas conduit (140) described above.

In the fifth test molten metal pump, certain part dimensions were set to test the relationship of such dimensions to campaign life performance of molten metal pumps. Specifically, the fifth test molten metal pump was similar to the third and fourth test molten metal pumps described above with respect to Examples 3 and 4. For instance, as similarly described above, unlike the first test molten metal pump described above, the fifth test molten metal pump used a substantially similar diameter for the transport conduit in both the inlet portion and the exit portion. Additionally, unlike the first test molten metal pump described above, the fifth test molten metal pump used an increased gas delivery conduit diameter to increase the size of the gas port relative to the diameter of the exit portion of the transport conduit. However, unlike the gas delivery conduit diameter used in the third and fourth test molten metal pumps, the gas delivery conduit diameter used in the fifth test molten metal pump was substantially similar to the diameter used in the transport conduit. The particular dimensions used are summarized below in Table 21.

TABLE 21
Fifth Test Molten Metal Pump - Dimensions

| Dimension | Measurement |
|---|---|
| Inlet Port Height Above Bath (in) | 2.75 |
| Inlet Port Depth Below Bath (in) | 3.75 |
| Inlet Portion - Inner Diameter (in) | 3.88 |
| Inlet Port Size (in) | 2.46 |
| Exit Port Height Above Bath (in) | 2.53 |
| Exit Portion - Inner Diameter (in) | 3.88 |
| Exit Port Angle (deg) | 38° |
| Gas Delivery Conduit - Inner Diameter (in) | 3.88 |
| Gas Port - Inner Diameter (in) | 3.88 |

The fifth test molten metal pump was then used in a galvanizing and galvannealing line to test campaign life performance. Two total tests were performed using a single version of the fifth test molten metal pump, but the single version of the fifth test molten metal pump was oriented on an opposite side of the introducer sheath for each test. This testing resulted in an observed campaign life performance of at least 35 days. Incidentally, in one of the tests, testing was ended prematurely due to an unrelated outage of the galvanizing and galvannealing line. The particular campaign life results are summarized below in Table 22, with the particular test number indicated as a whole number, and the side indicated with the letter “R” for right and the letter “L” for left (e.g., 1.R).

TABLE 22
Fifth Test Molten Metal Pump - Campaign Life

| Test No. | Campaign Life (Days) | Side of Sheath | Notes |
|---|---|---|---|
| 1.L | 9 | Left | Test Ended Early |
| 2.R | 35 | Right | Test ongoing |

Thus, the fifth test molten metal pump exhibited an improved campaign life relative to the first test molten metal pump with a 35-day campaign life (excluding the test where testing ended early). This improved campaign life was believed to be due to the relative increase of the ratio of the diameter the gas delivery conduit relative to the diameter of the exit portion of the transport conduit. As of Jun. 17, 2022, test 2.R has not been concluded and the fifth test molten metal pump was still operating. The test data described herein includes testing up to Jun. 17, 2022. However, the testing subsequently completed and test 2.R ultimately ran for a total campaign life of approximately 38 days, which was about 24 days longer than the average campaign life for the second, third, and fourth test molten metal pumps.

For test number 1.L, the test ended early. The test was ended early due to a scheduled outage for the equipment in use with the test molten metal pump. Thus, the early ending for test number 1.L was unrelated to performance of the test molten metal pump.

Unlike the testing associated with first and second test molten metal pumps described above, the testing associated with the fifth test molten metal pump included additional data collection related to observed pressures and flow rates. Such data was collected for both the first and second tests. The collected data is summarized below in Tables 23 and 24. Columns labeled “GA” and “GI” were used to identify whether the line was operating was operating for galvannealing (e.g., GA) or galvanizing (e.g., GI). A value of −5 is listed to indicate when operating in a particular mode.

TABLE 23
Test 1 - Summary of Pressure and Flow Data
Left Side

| | | PSI | SCFM | | |
|---|---|---|---|---|---|
| Date | Time | Effective | Flow | GA | GI |
| May 2, 2022 | 2:40 PM | 7 | 5 | −5 | |
| May 3, 2022 | 12:10 PM | 7 | 6 | −5 | |
| May 4, 2022 | 10:40 AM | 10 | 8.5 | −5 | |
| May 5, 2022 | 10:25 AM | 10 | 8.5 | −5 | |
| May 6, 2022 | 12:56 PM | 9.5 | 8.5 | −5 | |
| May 9, 2022 | 9:41 PM | 10 | 8 | −5 | |
| May 10, 2022 | 7:20 AM | 9.5 | 8.5 | −5 | |

TABLE 24
Test 2 - Summary of Pressure and Flow Data
Right Side

| | | PSI | SCFM | | |
|---|---|---|---|---|---|
| Date | Time | Effective | Flow | GA | GI |
| May 13, 2022 | 11:40 AM | 8.5 | 6 | | −5 |
| May 16, 2022 | 8:00 AM | 8 | 7 | | −5 |
| May 17, 2022 | 8:00 AM | 5 | 3.5 | | −5 |
| May 17, 2022 | 1:54 PM | 5 | 8 | | −5 |
| May 18, 2022 | 9:44 AM | 7.5 | 8 | | −5 |
| May 19, 2022 | 10:00 AM | 7.5 | 7.5 | | −5 |
| May 20, 2022 | 7:50 AM | 8.5 | 7.5 | | −5 |
| May 25, 2022 | 10:16 AM | 8.5 | 8.5 | −5 | |
| May 31, 2022 | 12:31 PM | 9 | 7 | −5 | |
| Jun 2, 2022 | 12:40 PM | 8 | 7 | −5 | |
| Jun 3, 2022 | 10:31 AM | 8.5 | 7 | −5 | |
| Jun 3, 2022 | 2:13 PM | 8 | 6 | −5 | |
| Jun 6, 2022 | 9:47 AM | 8 | 6 | −5 | |
| Jun 6, 2022 | 12:41 PM | 7.75 | 6 | −5 | |
| Jun 7, 2022 | 9:00 AM | 8 | 6 | −5 | |
| Jun 7, 2022 | 2:50 PM | 8 | 6.5 | −5 | |
| Jun 8, 2022 | 9:30 AM | 8 | 6 | −5 | |
| Jun 8, 2022 | 1:46 PM | 7.75 | 6 | −5 | |
| Jun 14, 2022 | 9:12 AM | 7.5 | 6 | −5 | |
| Jun 14, 2022 | 2:34 PM | 8 | 6 | −5 | |
| Jun 15, 2022 | 10:15 AM | 7.5 | 6 | −5 | |
| Jun 15, 2022 | 3:00 PM | 8 | 6 | −5 | |
| Jun 16, 2022 | 8:48 AM | 8 | 5.5 | −5 | |
| Jun 16, 2022 | 1:40 PM | 8 | 5.5 | −5 | |
| Jun 17, 2022 | 10:36 AM | 8 | 6 | −5 | |

In addition to data related to observed pressures and flow rates, data was also taken related to observed temperature. In particular, observed temperature was measured at the discharge from the gas source. This discharge was positioned about 25 to 30 feet from the test molten metal pump. The observed temperatures are shown below for the first and second tests in Tables 25 and 26, respectively.

TABLE 25
Test 1 - Observed Temperatures
Left Side

| | | Temp |
|---|---|---|
| Date | Time | º F. |
| May 2, 2022 | 2:40 PM | 245 |
| May 3, 2022 | 12:10 PM | 290 |
| May 4, 2022 | 10:40 AM | 340 |
| May 5, 2022 | 10:25 AM | 340 |
| May 6, 2022 | 12:56 PM | 340 |
| May 9, 2022 | 9:41 PM | 340 |
| May 10, 2022 | 7:20 AM | 340 |

TABLE 26
Test 2 - Observed Temperatures
Right Side

| | | Temp |
|---|---|---|
| Date | Time | º F. |
| May 13, 2022 | 11:40 AM | 235 |
| May 16, 2022 | 8:00 AM | 275 |
| May 17, 2022 | 8:00 AM | 75 |
| May 17, 2022 | 1:54 PM | 85 |
| May 18, 2022 | 9:44 AM | 80 |
| May 19, 2022 | 10:00 AM | 140 |
| May 20, 2022 | 7:50 AM | 275 |
| May 25, 2022 | 10:16 AM | 220 |
| May 31, 2022 | 12:31 PM | 280 |
| Jun. 2, 2022 | 12:40 PM | 275 |
| Jun. 3, 2022 | 10:31 AM | 275 |
| Jun. 3, 2022 | 2:13 PM | 275 |
| Jun. 6, 2022 | 9:47 AM | 275 |
| Jun. 6, 2022 | 12:41 PM | 275 |
| Jun. 7, 2022 | 9:00 AM | 273 |
| Jun. 7, 2022 | 2:50 PM | 275 |
| Jun. 8, 2022 | 9:30 AM | 275 |
| Jun. 8, 2022 | 1:46 PM | 275 |
| Jun. 14, 2022 | 9:12 AM | 260 |
| Jun. 14, 2022 | 2:34 PM | 275 |
| Jun. 15, 2022 | 10:15 AM | 275 |
| Jun. 15, 2022 | 3:00 PM | 275 |
| Jun. 16, 2022 | 8:48 AM | 275 |
| Jun. 16, 2022 | 1:40 PM | 280 |
| Jun. 17, 2022 | 10:36 AM | 280 |

As can be seen, observed temperature varied during operation between a high of 340° F. to and a low of 75° F. The average observed temperature was about 259° F.

### EXAMPLE 6

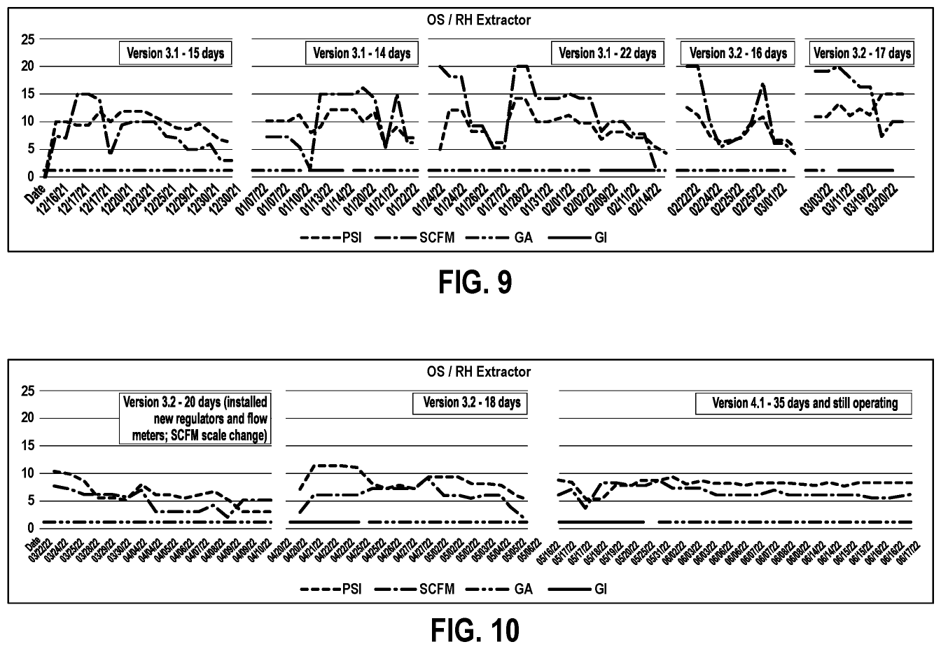

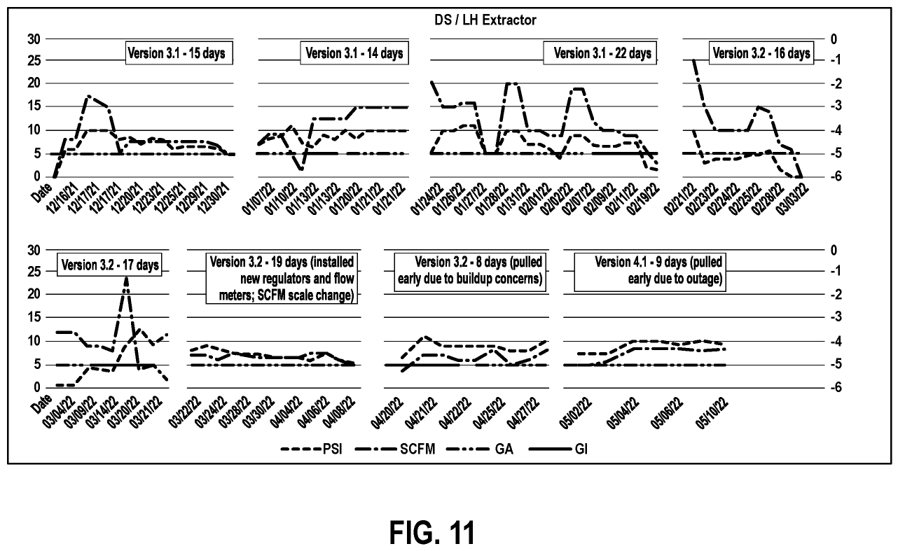

The pressure and flow data shown and described above was plotted for comparison purposes. In particular, plots for test molten metal pumps positioned on the right side of the introducer sheath are shown in FIGS. 9 and 10. Meanwhile, plots for molten metal pumps positioned on the left side of the introducer sheath are shown in FIG. 11.

### EXAMPLE 7

Further testing of the fifth test molten metal pump described above was conducted in a galvanizing and galvannealing line to further test campaign life performance.

Eighteen total tests were performed using a single version of the fifth test molten metal pump, but the single version of the fifth test molten metal pump was oriented on an opposite side of the introducer sheath for each test. This testing resulted in an observed average campaign life performance of 29.8 days on one side and 23.3 days on another side. Incidentally, in some of the tests, testing was ended prematurely due to unrelated outages of the galvanizing and galvannealing line. The particular campaign life results are summarized below in Table 26, with the particular test number indicated as a whole number, and the side indicated with the letter “R” for right and the letter “L” for left (e.g., 1.L).

TABLE 26
Fifth Test Molten Metal Pump - Campaign Life

| Test No. | Campaign Life (Days) | Side of Sheath | Notes |
|---|---|---|---|
| 1.L | 30.5 | Left | |
| 2.R | 25.5 | Right | |
| 3.L | 49.5 | Left | |
| 4.R | 41.5 | Right | |
| 5.L | 21.5 | Left | |
| 6.R | 55 | Right | |
| 7.L | 20 | Left | Test Ended Early |
| 8.R | 20 | Right | Test Ended Early |
| 9.L | 13 | Left | |
| 10.R | 25 | Right | |
| 11.L | 17 | Left | |
| 12.R | 20 | Right | |
| 13.L | 17 | Left | |
| 14.L | 31 | Left | |
| 15.R | 16 | Right | |
| 16.L | 10 | Left | |
| 17.R | 35 | Right | |
| 18.L | 9 | Left | Test Ended Early |

Thus, the fifth test molten metal pump exhibited an improved campaign life relative to the first test molten metal pump with a maximum observed campaign life of 55 days and an average campaign life of 27.2 days (excluding tests where testing ended early). As similarly discussed above, this improved campaign life was believed to be due to the relative increase of the ratio of the diameter the gas delivery conduit relative to the diameter of the exit portion of the transport conduit.

For test numbers 7.L, 8.R, and 18.L, the tests ended early. The tests ended early due to a scheduled outage for the equipment in use with the test molten metal pump. Thus, the early ending for test numbers 7.L, 8.R, and 18.L was unrelated to performance of the test molten metal pump.

### EXAMPLE 8

An apparatus for pumping molten metal, the apparatus comprising: a transport conduit, the transport conduit including an inlet portion and an exit portion, the inlet portion defining an inlet port, the exit portion defining an exit diameter and an exit port, the inlet portion being in communication with the exit portion to communicate molten metal from the inlet port to the exit port; and a gas conduit in communication with a gas source, the gas conduit defining a gas delivery conduit, the gas delivery conduit being in communication with the exit portion and defining a gas delivery diameter, a ratio of the gas delivery diameter to the exit diameter being 0.5 or more.

### EXAMPLE 9

The apparatus of Example 8, the ratio of the gas delivery diameter to the exit diameter being between 0.5 and 1.

### EXAMPLE 10

The apparatus of Example 8, the ratio of the gas delivery diameter to the exit diameter being 1.

### EXAMPLE 11

The apparatus of any of Examples 8 through 10, the transport conduit further including a connecting portion, the connecting portion being disposed between the inlet portion and the exit portion.

### EXAMPLE 12

The apparatus of Example 11, the inlet portion and the exit portion extending from the connecting portion, the inlet port being defined on an opposite end relative to the connecting portion, the exit port being defined on an opposite end relative to the connecting portion.

### EXAMPLE 13

The apparatus of any of Examples 11 or 12, the inlet portion, the exit portion, and the connecting portion being arranged such that the transport conduit defines a J or U-shaped configuration.

### EXAMPLE 14

The apparatus of any of Examples 8 through 13, the inlet portion defining an inlet diameter, the inlet diameter corresponding to the exit diameter.

### EXAMPLE 15

The apparatus of any of Examples 8 through 13, the transport conduit defining a substantially consistent diameter.

### EXAMPLE 16

The apparatus of any of Examples 8 through 15, the gas conduit further defining a gas supply conduit and a neck, the neck being disposed between the gas supply conduit and the gas delivery conduit.

### EXAMPLE 17

The apparatus of Example 16, the gas supply conduit defining a gas supply diameter, the gas supply diameter being less than the gas delivery diameter.

### EXAMPLE 18

The apparatus of Example 17, the gas delivery diameter being four times greater or more than the gas supply diameter.

### EXAMPLE 19

The apparatus of any of Examples 16 through 18, the neck being configured to increase the pressure of gas within the gas delivery conduit relative to the gas supply conduit.

### EXAMPLE 20

The apparatus of any of Examples 8 through 19, further comprising the gas source, the gas source being configured to supply an inert gas to the gas conduit.

### EXAMPLE 21

The apparatus of any of Examples 8 through 19, further comprising the gas source, the gas source being configured to communicate heated gas to the gas conduit.

### EXAMPLE 22

The apparatus of any of Examples 8 through 19, further comprising the gas source, the gas source being configured to communicate gas heated to a temperature of 300° F. or more to 500° F. or less to the gas conduit.

### EXAMPLE 23

A system for coating steel, the system comprising: a dip tank configured to contain molten metal; an introducer sheath, a portion of the introducer sheath extending into the molten metal contained within the dip tank, the introducer sheath defining a hollow interior; and a molten metal pump, the molten metal pump having a transport conduit and a gas conduit, the transport conduit including an inlet portion and an exit portion, the inlet portion extending into the hollow interior of the introducer sheath, at least a portion of the exit portion being disposed outside of the hollow interior of the introducer sheath such that the molten metal pump is configured to communicate molten metal relative to the hollow interior of the introducer sheath, the gas conduit being configured to communicate a gas pressure front to the exit portion to lift the molten metal through the exit portion.

### EXAMPLE 24

The system of Example 23, the transport conduit further including a connecting portion disposed between the inlet portion and the exit portion, the connecting portion being in communication with both the inlet portion and the exit portion, the inlet portion extending from the connecting portion at a first angle relative to a horizontal plane, the exit portion extending from the connecting portion at a second angle relative to the horizontal plane, the first angle being greater than the second angle.

### EXAMPLE 25

The system of Example 24, the first angle being between 80° and 110° relative to the horizontal plane, the second angle being between 50° and 70° relative to the horizontal plane.

### EXAMPLE 26

The system of any of Examples 23 through 24, the gas conduit intersecting with the exit portion to define a gas port, the gas port defining a first diameter, the exit portion defining a second diameter, the first diameter being no less than ½ of the second diameter.

### EXAMPLE 27

A method for communicating molten metal from a first portion of a molten metal bath to a second portion of the molten metal bath, the method comprising: receiving the molten metal within an inlet to fill an inlet conduit with the molten metal; communicating the molten metal from the inlet conduit to an exit conduit; injecting a heated gas into the exit conduit to fill a cross-sectional plane of the exit conduit with the heated gas; and lifting the molten metal within the exit conduit using the heated gas.

### EXAMPLE 28

The method of Example 27, the heated gas being at a temperature of at least 300° F.

### EXAMPLE 29

The method of Example 27, the heated gas being at a temperature between 300° F. and 500° F.

### EXAMPLE 30

The method of any of Examples 28 through 29, further comprising generating a pressure front within the heated gas prior to the step of injecting the heated gas.

### EXAMPLE 31

The method of Example 30, the step of generating a pressure front within the heated gas includes transitioning the heated gas from a high velocity low pressure gas to a low velocity high pressure gas.

I/We claim:

1. An apparatus for pumping molten metal, the apparatus comprising:
(a) a transport conduit, the transport conduit including an inlet portion and an exit portion, the inlet portion defining an inlet port, the exit portion defining an exit diameter and an exit port, the inlet portion being in communication with the exit portion to communicate molten metal from the inlet port to the exit port; and
(b) a gas conduit in communication with a gas source, the gas conduit defining a gas delivery conduit, the gas delivery conduit being in communication with the exit portion and defining a gas delivery diameter, a ratio of the gas delivery diameter to the exit diameter being 0.5 or more.

2. The apparatus of claim 1, the ratio of the gas delivery diameter to the exit diameter being between 0.5 and 1.

3. The apparatus of claim 1, the ratio of the gas delivery diameter to the exit diameter being 1.

4. The apparatus of claim 1, the transport conduit further including a connecting portion, the connecting portion being disposed between the inlet portion and the exit portion.

5. The apparatus of claim 4, the inlet portion and the exit portion extending from the connecting portion, the inlet port being defined on an opposite end relative to the connecting portion, the exit port being defined on an opposite end relative to the connecting portion.

6. The apparatus of claim 4, the inlet portion, the exit portion, and the connecting portion being arranged such that the transport conduit defines a J or U-shaped configuration.

7. The apparatus of claim 1, the inlet portion defining an inlet diameter, the inlet diameter corresponding to the exit diameter.

8. The apparatus of claim 1, the transport conduit defining a substantially consistent diameter.

9. The apparatus of claim 1, the gas conduit further defining a gas supply conduit and a neck, the neck being disposed between the gas supply conduit and the gas delivery conduit.

10. The apparatus of claim 9, the gas supply conduit defining a gas supply diameter, the gas supply diameter being less than the gas delivery diameter.

11. The apparatus of claim 10, the gas delivery diameter being four times greater or more than the gas supply diameter.

12. The apparatus of claim 9, the neck being configured to increase the pressure of gas within the gas delivery conduit relative to the gas supply conduit.

13. The apparatus of claim 1, further comprising the gas source, the gas source being configured to supply an inert gas to the gas conduit.

14. The apparatus of claim 1, further comprising the gas source, the gas source being configured to communicate heated gas to the gas conduit.

15. The apparatus of claim 1, further comprising the gas source, the gas source being configured to communicate gas heated to a temperature of 300° F. or more to 500° F. or less to the gas conduit.

16. A system for coating steel, the system comprising:
(a) a dip tank configured to contain molten metal;
(b) an introducer sheath, a portion of the introducer sheath extending into the molten metal contained within the dip tank, the introducer sheath defining a hollow interior; and
(c) a molten metal pump, the molten metal pump having a transport conduit and a gas conduit, the transport conduit including an inlet portion and an exit portion, the inlet portion extending into the hollow interior of the introducer sheath, at least a portion of the exit portion being disposed outside of the hollow interior of the introducer sheath such that the molten metal pump is configured to communicate molten metal relative to the hollow interior of the introducer sheath, the gas conduit being configured to communicate a gas pressure front to the exit portion to lift the molten metal through the exit portion.

17. The system of claim 16, the transport conduit further including a connecting portion disposed between the inlet portion and the exit portion, the connecting portion being in communication with both the inlet portion and the exit portion, the inlet portion extending from the connecting portion at a first angle relative to a horizontal plane, the exit portion extending from the connecting portion at a second angle relative to the horizontal plane, the first angle being greater than the second angle.

18. The system of claim 17, the first angle being between 80° and 110° relative to the horizontal plane, the second angle being between 50° and 70° relative to the horizontal plane.

19. The system of claim 16, the gas conduit intersecting with the exit portion to define a gas port, the gas port defining a first diameter, the exit portion defining a second diameter, the first diameter being no less than ½ of the second diameter.

20. A method for communicating molten metal from a first portion of a molten metal bath to a second portion of the molten metal bath, the method comprising:
(a) receiving the molten metal within an inlet to fill an inlet conduit with the molten metal;
(b) communicating the molten metal from the inlet conduit to an exit conduit; injecting a heated gas into the exit conduit to fill a cross-sectional plane of the exit conduit with the heated gas; and
(c) lifting the molten metal within the exit conduit using the heated gas.
